(19) United States
(12) Patent Application Publication
(10) Pub. No.: US 2018/0129512 A1
(43) Pub. Date: May 10, 2018

(54) METHOD AND APPARATUS FOR SERVING ONLINE COMMUNITIES OF USERS

(71) Applicant: 24/7 Customer, Inc., Campbell, CA (US)

(72) Inventors: Bhupinder SINGH, Bangalore (IN); R. Mathangi SRI, Bangalore (IN)

(21) Appl. No.: 15/346,653

(22) Filed: Nov. 8, 2016

(51) Int. Cl. G06F 9/44; H04L 29/08; H04L 12/24; G06F 3/0482; G06F 3/0483; G06F 3/0481

(52) U.S. Cl. CPC G06F 9/4446; H04L 67/02; H04L 41/046; G06F 3/04883; G06F 3/0483; G06F 3/0481; G06F 3/0482

(57) ABSTRACT

A computer-implemented method and apparatus for serving online communities of users includes effecting display of an interactive section on at least a portion of a user interface of a website upon receiving a user input indicative of a need for assistance. The interactive section is displayed to enable the user to post one or more queries to at least one relevant community of users from among a plurality of community of users associated with the website. Further, an interaction is facilitated between the user and one or more users associated with the at least one relevant community of users or between the user and the agent using the interactive section in response to posting of the one or more queries by the user.

### TECHNICAL FIELD

The invention generally relates to customer service mechanisms and, more particularly, to a method and apparatus for serving online communities of users.

### BACKGROUND

The conventional approach of serving customers involves providing assistance to the customers over one of several communication channels using dedicated customer care representatives. For example, a customer may connect with a customer care representative over a voice channel, i.e. conduct a telephonic conversation, to seek assistance. In another illustrative example, a customer may chat with a customer care representative, i.e. use a chat interaction channel, to seek desired assistance. Most of the interactions between the customers and the customer care representatives are one-on-one interactions, thus putting limitations on how many customers can be handled at any given point in time.

In many scenarios, the customers may have to wait a long time to interact with a customer care representative because all available customer care representatives may be engaged in serving other customers. The prolonged wait, in addition to ruining a customer service experience, may also cause some customers to abandon the interaction, thereby causing a loss of business for the enterprise.

More recently, some enterprises have employed resources to service customer queries through social media. However, the customer having posted a query on an enterprise social media interface may not receive a response in a timely manner, and as such the customers may not receive answers to their queries at the point of interest, such as for example, when they are shopping.

Accordingly, there is a need to improve customer service mechanisms such that customers are provided assistance in a timely manner without having to wait for prolonged durations of time. Further, it would be advantageous to provide assistance to the customers during an on-going customer engagement with an enterprise and not at a later point in time.

### SUMMARY

In an embodiment of the invention, a computer-implemented method for serving an online user is disclosed. The method effects, by a processor, display of an interactive section on at least a portion of a user interface (UI) associated with a website during a current journey of a user on the website. The interactive section is displayed to enable the user to post one or more queries to at least one relevant community of users from among a plurality of community of users associated with the website. The at least one relevant community of users is identified, at least in part, based on the current journey of the user on the website. The method facilitates, by the processor, interaction between the user and at least one of: (1) one or more users associated with the at least one relevant community of users, and (2) an agent associated with the website. The interaction is facilitated using the interactive section subsequent to posting of the one or more queries by the user.

In another embodiment of the invention, a system for serving online communities of users includes at least one processor and a memory. The memory stores machine executable instructions therein, that when executed by the at least one processor, causes the system to effect display of an interactive section on at least a portion of an UI associated with a website during a current journey of a user on the website. The interactive section is displayed to enable the user to post one or more queries to at least one relevant community of users from among a plurality of community of users associated with the website. The at least one relevant community of users is identified, at least in part, based on the current journey of the user on the website. The system facilitates interaction between the user and at least one of: (1) one or more users associated with the at least one relevant community of users, and (2) an agent associated with the website. The interaction is facilitated using the interactive section subsequent to posting of the one or more queries by the user.

In another embodiment of the invention, a computer-implemented method for serving an online user is disclosed. The method receives, by a processor, a user input during a current journey of a user on a website. The user input is indicative of a need for assistance. The method effects, by the processor, display of an interactive section on at least a portion of a UI associated with a website during the current journey of the user on the website in response to receiving the user input. The interactive section is displayed to enable the user to post one or more queries to at least one relevant community of users from among a plurality of community of users associated with the website. The method receives using the interactive section, by the processor, the one or more queries posted to the at least one relevant community of users by the user. The method effects, by the processor, display of answers provided in response to the one or more queries by at least one of: (1) one or more users associated with the at least one relevant community of user; and (2) an agent associated with the website. The interaction is facilitated using the interactive section in response to posting of the one or more queries by the user.

### BRIEF DESCRIPTION OF THE FIGURES

FIG. 1 shows an example representation of an online user accessing a website using an electronic device in accordance with an embodiment of the invention;

FIG. 2 is a block diagram of a system configured to serve online communities of users in accordance with an;

FIG. 3 shows an example user interface (UI) of a website for depicting a user selectable option displayed to an online user in accordance with an embodiment of the invention;

FIG. 4 shows an interactive section displayed to a user on a portion of the UI of the website during a current journey of the user on the website in accordance with an embodiment of the invention;

FIG. 5 shows a UI with customized content displayed to the user in accordance with an embodiment of the invention;

FIG. 6 shows an example ongoing chat interaction between the user and users of the identified relevant communities on the interactive section in accordance with an embodiment of the invention;

FIG. 7 depicts a best rated answer displayed to a user in response to a user query in accordance with an embodiment of the invention;

FIG. 8 is a flow diagram of an example method for serving an online user in accordance with an embodiment of the invention; and

FIG. 9 is a flow diagram of an example method for serving an online user in accordance with an embodiment of the invention.

### DETAILED DESCRIPTION

The detailed description provided below in connection with the appended drawings is intended as a description of the present embodiments of the invention and is not intended to represent the only forms in which the present invention may be constructed or used. However, the same or equivalent functions and sequences may be accomplished by different embodiments of the invention.

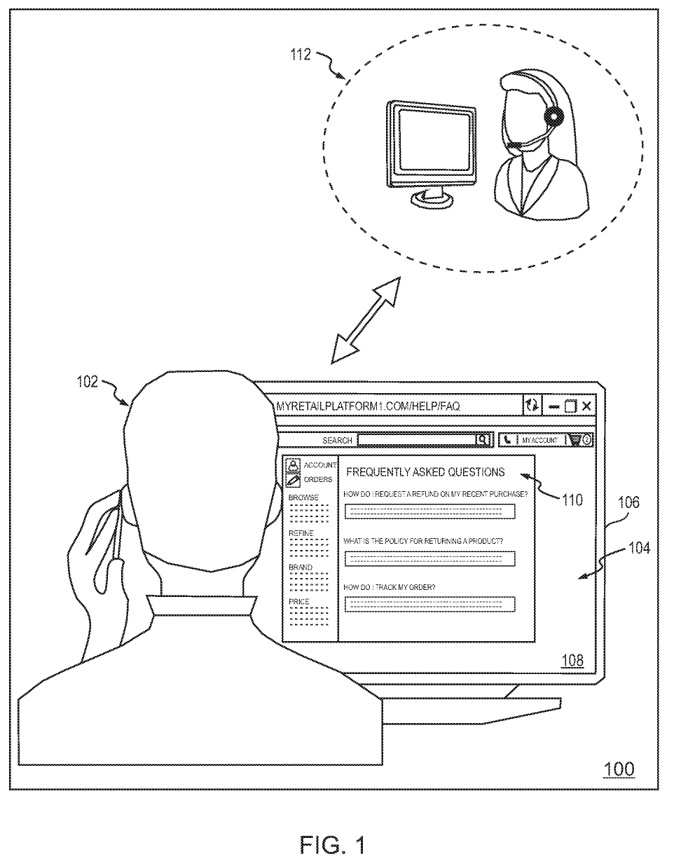

FIG. 1 shows an example representation 100 of an online user 102 accessing a website 104 using an electronic device 106 in accordance with an embodiment of the invention. The website 104 may be associated with a plurality of Web pages related to an enterprise. The term ‘enterprise’ as used herein may refer to a corporation, an institution, a small/medium sized company, or even a brick and mortar entity. For example, the enterprise may be a banking enterprise, an educational institution, a financial trading enterprise, an aviation company, a retail outlet, an e-commerce entity, or any such public or private sector enterprise. It is understood that many customers may use products, services and/or information offered by the enterprise. The existing and/or potential customers of the enterprise offerings are referred to herein as ‘users.’ The online user 102 is depicted to be a user of products/services offered by an enterprise associated with the website 104 for example purposes only. It is noted that the users of the enterprise offerings may not be limited to individuals. Indeed, in many example scenarios, groups of individuals or other enterprise entities may also be users of the enterprise offerings.

The representation 100 further depicts the user 102 accessing the website 104 using the electronic device 106 embodied as a desktop computer. It is noted that a user may use any electronic device, such as but not limited to, a smartphone, a tablet computer, a mobile phone, a laptop computer, a personal digital assistant, a web-enabled wearable device, and the like, for accessing the website 104 over a communication network. Examples of the communication network may include wired networks, wireless networks, or a combination thereof. Examples of wired networks may include the Ethernet, local area networks (LANs), fiber-optic cable networks, and the like. Examples of wireless networks may include cellular networks like GSM/3G/4G/CDMA based networks, wireless LANs, Bluetooth or Zigbee networks, and the like. An example of a combination of wired and wireless networks may include the Internet. Further, it is noted that the electronic device 106 may include necessary applications, such as for example, a Web browser application that enables the online user 102 to access the website 104 over the communication network.

Users, such as the online user 102, may access the website 104 for a variety of reasons, such as for example, to view enterprise product/service offerings, to pay bills, to provide feedback, to register a complaint, and the like. In many scenarios, the users may have questions and may access the website 104 to receive answers to their questions. For example, the users may wish to know more about product specifications, to enquire about billing or payment, to configure a product or troubleshoot an issue related to a product, to enquire about upgrades, to enquire about shipping of a product, to follow up about a previous query, and the like. In such scenarios, the users may access a Web page related to Frequently Asked Questions (FAQ) to view answers related to their respective queries. Such a scenario is depicted in FIG. 1. More specifically, the online user 102 is depicted to be viewing a website user interface 108 showing content 110 related to FAQs. In some embodiments of the invention, the online user 102 may not be satisfied with the content provided on the UI 108 and may contact a customer care representative (also referred to herein as an agent), such as the agent 112.

Typically, the online user 102 may have to wait for a prolonged duration of time to interact with a customer care representative, such as the agent 112, because all available agents deployed by the enterprise for customer sales and support may be engaged in serving other customers. The prolonged wait, in addition to ruining a customer service experience for the online user 102, may also cause the online user 102 to abandon the interaction, thereby causing a loss of business for the enterprise.

In some example scenarios, the online user 102 may also choose to post a query on a social media forum associated with the enterprise. However, in such scenarios, the online user 102 may not receive an instantaneous response and as such may have to wait until a dedicated agent assigned for responding to such user queries responds to the user's query.

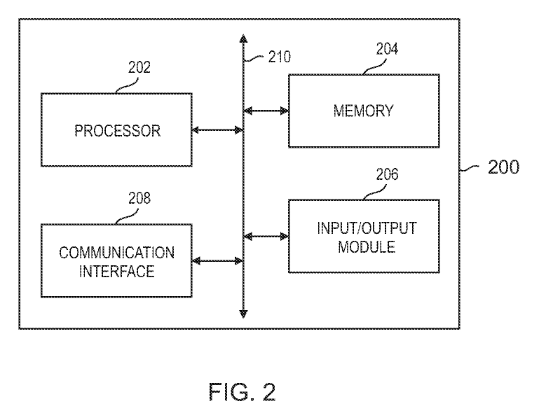

Various embodiments of the invention provide methods and systems that are capable of overcoming these and other obstacles and providing additional benefits. More specifically, methods and systems disclosed herein suggest providing assistance to the users in timely manner without the users having to wait to receive answers to their queries. In at least one example embodiment, an interactive section is displayed to a user on the website during an on-going journey of the customer on the website. The interactive section enables the user to post queries to one or more communities of users currently active on the website. The user may receive answers to queries from other users in the communities or, in some cases, an agent assigned to a community may also choose to respond to a user query. Because such assistance is provided to the user during an ongoing user interaction without having to wait for prolonged duration of time, a customer experience quotient improves substantially and moreover customer churn is also reduced. A system for serving online communities of users is explained with reference to FIG. 2.

FIG. 2 is a block diagram of a system 200 configured to serve online communities of users in accordance with an embodiment of the invention. As explained with reference to FIG. 1, enterprises offer several dedicated interaction channels to engage with current and potential users of their offerings. One such interaction channel is the Web channel or, more specifically, the website of the enterprise. Several users may visit the enterprise website to view product/service/information offerings, to pay bills, to seek discounts, etc. Such users, based on their activity on the website, may be classified into different communities (as will be explained in further detail later). The communities of users are referred to herein as ‘online communities of users.’ Further, the term ‘serving the online communities of users,’ in at least one example embodiment, may refer to enabling users receive respective desired assistance. For example, a user may seek assistance in troubleshooting an issue with a recently brought product. In such a scenario, serving the user may refer to enabling the user in receiving desired technical assistance in a timely manner. Similarly, other users may also receive respective desired assistance in a timely manner.

In FIG. 2, the system 200 includes at least one processor, such as a processor 202, and a memory 204. It is noted that although the system 200 is depicted to include only one processor, the system 200 may include a greater number of processors therein. In an embodiment, the memory 204 is capable of storing machine executable instructions. Further, the processor 202 is capable of executing the stored machine executable instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and non-volatile memory devices. For example, the memory 204 may be embodied as magnetic storage devices, such as hard disk drives, floppy disks, magnetic tapes, etc.; optical magnetic storage devices, e.g. magneto-optical disks, CD-ROM (compact disc read only memory), CD-R (compact disc recordable), CD-R/W (compact disc rewritable), DVD (Digital Versatile Disc), BD (Blu-ray® Disc); and semiconductor memories, such as mask ROM, PROM (programmable ROM), EPROM (erasable PROM), flash ROM, and RAM (random access memory); etc.

The system 200 also includes an input/output module 206 (hereinafter referred to as ‘I/O module 206’) and a communication interface 208. The I/O module 206 is configured to facilitate provisioning of an output to a user of the system 200. In an embodiment, the I/O module 206 may be configured to provide a user interface (UI) configured to provide options or any other display to the user. The I/O module 206 may also include mechanisms configured to receive inputs from the user of the system 200. The I/O module 206 is configured to be in communication with the processor 202 and the memory 204. Examples of the I/O module 206 include, but are not limited to, an input interface and/or an output interface. Examples of the input interface may include, but are not limited to, a keyboard, a mouse, a joystick, a keypad, a touch screen, soft keys, a microphone, and the like. Examples of the output interface may include, but are not limited to, a display such as a light emitting diode display, a thin-film transistor (TFT) display, a liquid crystal display, an active-matrix organic light-emitting diode (AMOLED) display, a microphone, a speaker, a ringer, a vibrator, and the like. In an example embodiment, the processor 202 may include I/O circuitry configured to control at least some functions of one or more elements of the I/O module 206, such as, for example, a speaker, a microphone, a display, and/or the like. The processor 202 and/or the I/O circuitry may be configured to control one or more functions of the one or more elements of the I/O module 206 through computer program instructions, for example, software and/or firmware, stored on a memory, for example, the memory 204, and/or the like, accessible to the processor 202.

The communication interface 208 is configured to enable the system 200 to communicate with other entities, such as for example, Web servers hosting enterprise websites. The communication with the other entities may be realized over various types of wired or wireless networks. In at least some embodiments, the communication interface 208 may include relevant application programming interfaces (APIs) to communicate with the Web servers. In an example scenario, the communication interface 208 may receive activity data related to activity of plurality of users on an enterprise website. Additionally, the system 200 may also be configured to receive information related to user input or user selection performed by each user on the website. The communication interface 208 may also cause display of content, such as an interactive section, on the website as will be explained in further detail later.

In an embodiment, various components of the system 200, such as the processor 202, the memory 204, the I/O module 206, and the communication interface 208 are configured to communicate with each other via or through a centralized circuit system 210. The centralized circuit system 210 may be various devices configured to, among other things, provide or enable communication between the components (202-208) of the system 200. In certain embodiments, the centralized circuit system 210 may be a central printed circuit board (PCB), such as a motherboard, a main board, a system board, or a logic board. The centralized circuit system 210 may also, or alternatively, include other printed circuit assemblies (PCAs) or communication channel media.

It is understood that the system 200 as illustrated and hereinafter described is merely illustrative of a system that could benefit from embodiments of the invention and, therefore, should not be taken to limit the scope of the invention. It is noted that the system 200 may include fewer or more components than those depicted in FIG. 2. In an embodiment, the system 200 may be implemented as a platform including a mix of existing open systems, proprietary systems, and third party systems. In another embodiment, the system 200 may be implemented completely as a platform including a set of software layers on top of existing hardware systems. In an embodiment, one or more components of the system 200 may be deployed in a Web server. In another embodiment, the system 200 may be a standalone component in a remote machine connected to a communication network (such as a communication network explained with reference to FIG. 1) and capable of executing a set of instructions (sequential and/or otherwise) to serve online communities of users. Moreover, the system 200 may be implemented as a centralized system or, alternatively, the various components of the system 200 may be deployed in a distributed manner while being operatively coupled to each other. In an embodiment, one or more functionalities of the system 200 may also be embodied as a client within devices, such as customers' devices. In another embodiment, the system 200 may be a central system that is shared by or accessible to each of such devices.

The serving of the online communities of users by the system 200 is hereinafter explained with reference to one online user, such as the online user 102 explained with reference to FIG. 1. It is noted the system 200 may be caused to serve, or more specifically, to enable several other online users to receive desired assistance in a similar manner.

An online user (also interchangeably referred to herein as a ‘user’) may visit a website of an enterprise for several reasons as described in FIG. 1. In at least one example embodiment, the processor 202 is configured to, with the content of the memory 204, cause the system 200 to track user activity on the website during the current journey of the user on the website. The term ‘current journey’ as used herein refers to current visit to the website involving accessing of one or more Web pages associated with the website. In an illustrative example, the system 200 may be caused to use tags, such as HTML tags or JavaScript tags on the various elements of the website or, alternatively, the system 200 may be caused to open up a socket connection to capture information related to user activity on the website. The captured user activity on the website may include information such as Web pages visited, time spent on each Web page, menu options accessed, drop-down options selected or clicked, mouse movements, hypertext mark-up language (HTML) links those which are clicked and those which are not clicked, focus events (for example, events during which the user has focused on a link/webpage for a more than a predetermined amount of time), non-focus events (for example, choices the user did not make from information presented to the user (for examples, products not selected) or non-viewed content derived from scroll history of the user), touch events (for example, events involving a touch gesture on a touch-sensitive device such as a tablet), non-touch events, and the like. In at least one example embodiment, the communication interface 208 may be configured to receive such information from the Web server hosting the Web pages associated with the website and logging information related to the user activity on the website.

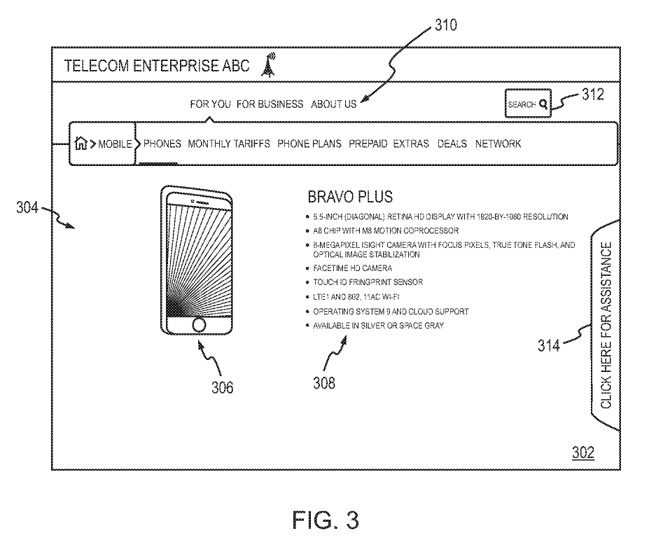

In at least one example embodiment, the system 200 may be caused to display a user selectable option on a user interface of each Web page associated with the website. The user selectable option may display a message such as for example ‘Need Help’ or ‘Speak with our agent.’ In case the user requires assistance at any stage during the current journey, the user may provide a click (or a touch) input to select the user selectable option to request desired assistance. In at least one embodiment, the user selectable option may be embodied as a tab, an icon, a floating widget, a fixed widget, an infographic, and the like. An example user selectable option displayed to a user is depicted in FIG. 3.

Referring now to FIG. 3, an example user interface (UI) 302 of a website 304 is shown for depicting a user selectable option 314 displayed to an online user, in accordance with an embodiment of the invention. The website 304 is depicted to correspond to a telecom enterprise ABC for illustration purposes. Further, the UI 302 is depicted to display an image 306 of a smartphone along with a text portion 308 outlining the specification of the smartphone. It is noted that the UI 302 displaying the image portion 306 of the smartphone along with the corresponding specification is shown herein for illustration purpose. The website 104 may similarly include content related to several other models of phones and/or other telecom products (such as SIM cards for example) and/or services (for example, postpaid billing, pre-paid billing, monthly tariffs, etc.).

The UI 302 also depicts a tab portion 310 exemplarily depicted to display tabs ‘FOR YOU,’ FOR BUSINESS,' and ‘ABOUT US.’ Further, each of these tabs are associated with sub-tabs, such as for example, the ‘FOR YOU’ tab is associated with sub tabs ‘PHONES,“MONTHLY TARIFF S,”PHONE PLANS,’ PREPAID,' ‘EXTRAS,’ ‘DEALS,’ and ‘NETWORK.’ The UI 302 also depicts a search box 312 configured to enable the user to provide a text input therein and retrieve Web pages associated with content related to the text input.

The UI 302 also depicts the user selectable option 314 displaying text ‘CLICK HERE FOR ASSISTANCE.’ In an example scenario, an online user (not shown in FIG. 3) may be interested in purchasing the smartphone ‘BRAVO PLUS’ displayed on the UI 302. However, the online user may wish to learn about additional features not mentioned in the specification or have any such related query. For example, the online user may wish to know the shipping options for a particular destination. In another illustrative example, the online user may wish to know what applications come pre-loaded with purchase of the smartphone. To learn more information or receive answers to queries, the online user may choose to seek assistance by providing a selection input, for example a touch input or a mouse click input, to select the user selectable option 314. The provisioning of the selection input (also referred to herein as user input) by the user during the current journey on the website may be received by the system 200 of FIG. 2 using the communication interface 208.

Referring now to FIG. 2, in at least one example embodiment, the processor 202 is configured to, with the content of the memory 204, cause the system 200 to effect display of an interactive section on at least a portion of a user interface (UI) associated with a website during a current journey of a user on the website. The interactive section is displayed in response to receiving the user input indicative of a need for assistance. More specifically, upon receiving information related to the provisioning of the selection input, for example, clicking on the user selectable option 314 displaying text ‘CLICK HERE FOR ASSISTANCE,’ an interactive section may be displayed on at least one portion of the website UI, such as the UI 302. The interactive section may be displayed to enable the user to post one or more queries to at least one relevant community of users associated with the website. The posting of queries to the at least one relevant community of users is further explained hereinafter.

In at least one embodiment, the system 200 may be caused to configure a plurality of community of users based on the users' attributes related to at least one of: purchase propensity, uniform resource locator (URL) categorization, sales or service categorization, current journey, online behavior, and omnichannel interaction data. For example, all users who are most likely to purchase a particular product (for example, a BRAVO PLUS' smartphone) may configure one community such as, for example, community ‘BRAVO PLUS,’ whereas all users who are most likely to purchase a 60$ monthly tariff plan may configure another community, such as for example community ‘60$ Plan.’ Some users may wish to purchase a smartphone, as well as the monthly tariff plan. Accordingly, users wishing to purchase both the smartphone and monthly tariff plan may also configure a community of users, such as for example community ‘Phone Plan X1.’ Accordingly, based on respective purchase propensity, a plurality of communities may be configured by the system 200. Active users may then be classified into one or more of those communities based on their respective activity on the website. User activity on the website, such as products selected, images viewed, pages visited, time spent on a particular Web page, and the like, may be tracked and, based on the tracked user activity, the propensity to purchase may be predicted. Further, based on the predicted propensity, the active users may be classified into one or more communities of users.

In another illustrative example, users who have visited a particular sequence of Web pages associated with a website may be grouped together to configure one community of users, such as for example ‘Don't know what to purchase’ community. For example, active users who have visited a variety of Web pages and checked an assortment of products/services may be classified into the ‘Don't know what to purchase’ community.

In yet another illustrative example, active users may be classified based on their respective purchase (or sales) or service categorization. More specifically, active users who have visited the website with a service requirement (for example, to troubleshoot an issue with a purchased product, to customize a monthly plan, to register a complaint, to provide a feedback, etc.) may be classified into a ‘service community’ of users. Similarly, active users who have visited the website to purchase a product or a service, i.e. a sales related requirement, may be classified into another community of users.

In the case of active users who are repeat customers, information related to their past activity (for example, online behavior such as a propensity to purchase online, propensity to chat with an agent, etc.) may be collated. Further, user activity information may be collated across various interaction channels. Such data collated across interaction channels is referred to herein as omnichannel data. For example, historic user interactions with agents on phone or chat interactions, IVR calls, social media interactions, and the like, may be collated to configure the omnichannel data corresponding to the user. The omnichannel data along with the current journey information, i.e. Web pages visited, products viewed, images clicked, etc., may be used by the system 200 to classify the active users into one or more communities of users.

As explained above, the active users on the website may be classified into a plurality of communities. For an active user on a website seeking assistance, in at least one example embodiment, the system 200 may be caused to identify one or more community of users from among the plurality of community of users based on a commonality in activity on the website associated with the user and the identified community of users. For example, the system 200 may be caused to identify one or more communities as relevant based on the current journey of the user on the website.

In an embodiment, the tracked user activity during the current journey of the user on the website may be used to identify the at least one relevant community of users. In an illustrative example, if the user is comparing two models of smartphones and is not sure which one to purchase, and, thereafter requests assistance, for example by clicking on a ‘Need assistance’ icon, then an interactive section may be displayed to the user. The interactive section may be configured to display at least one community of users which is relevant to the current journey of the user. For example, communities related to either of the two phones, or even a combined community of users associated with the two phones, may be displayed on the interactive section. The one or more relevant communities may be displayed to the user to enable the user to post one or more queries to these communities and seek desired assistance.

In at least one example embodiment, the system 200 may further be caused to facilitate interaction between the user and at least one of (1) one or more users associated with the identified one or more relevant communities of users, and (2) an agent associated with the website. One or more agents may be dedicated to serve online users visiting the website. In an embodiment, each community of users may be assigned an agent who may supervise the interaction between the user and other users in the community, provide answers to queries if required, rate answers and, in general, provide assistance to the users associated with community. In at least one example embodiment, the system 200 may be caused to facilitate interaction between the user posting the query and other users in the identified community and/or between the user and the agent associated with the community using the interactive section. In an embodiment, the system 200 may be caused to facilitate the interaction by effecting display of answers provided by the other users or the agent in response to the query posted by the user.

In some embodiments, a user query may have been previously asked and also answered by other users in the community of users. Accordingly, if a query posted by the user corresponds to a previously asked query, then previously provided answers provided to that query may be displayed to the user. In some embodiments, the system 200 may be caused to effect display of a past interaction history associated with each of the one or more relevant communities on the interactive section upon receiving user request. The user may view past interaction history and receive answers/clarifications to a query based on the prior question-answer related interactions associated with the community.

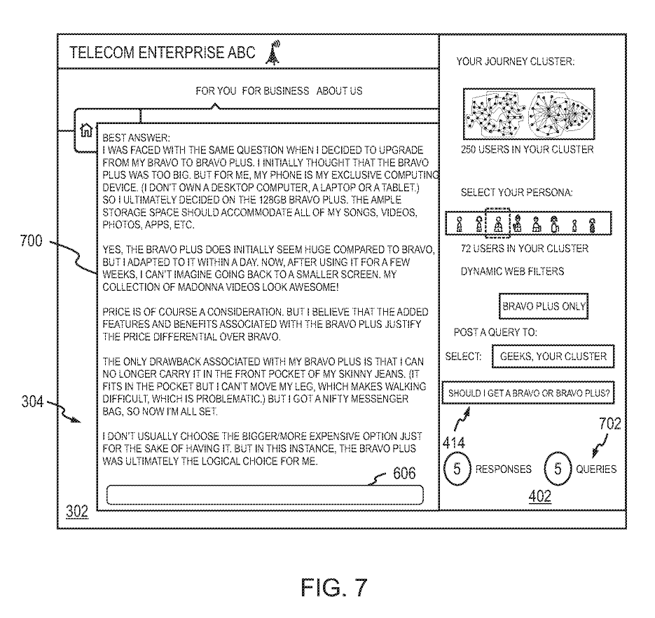

In some embodiments, answers to queries may be rated such that each answer is associated with rating. For example, answers to queries may be rated by users posting the queries, by other users, or even by agents monitoring the community interaction. In an illustrative example, an answer can be up-voted to indicate a positive rating or down-voted to indicate a negative rating. In another illustrative example, each answer may be associated with, for example, a five-star rating scale, and a user can click on stars to provide an indication of how useful the answer was, or whether the answer satisfactorily addressed the query or not. The individual ratings provided to an answer by several users and/or the agent may be used to compute an overall rating for the answer. For example, all ratings may be averaged to determine the overall rating for the answer. In at least one example embodiment, the system 200 may be caused to effect display of a best rated answer to a user query using the interactive section. The display of the best rated answer is further explained later with reference to FIG. 7.

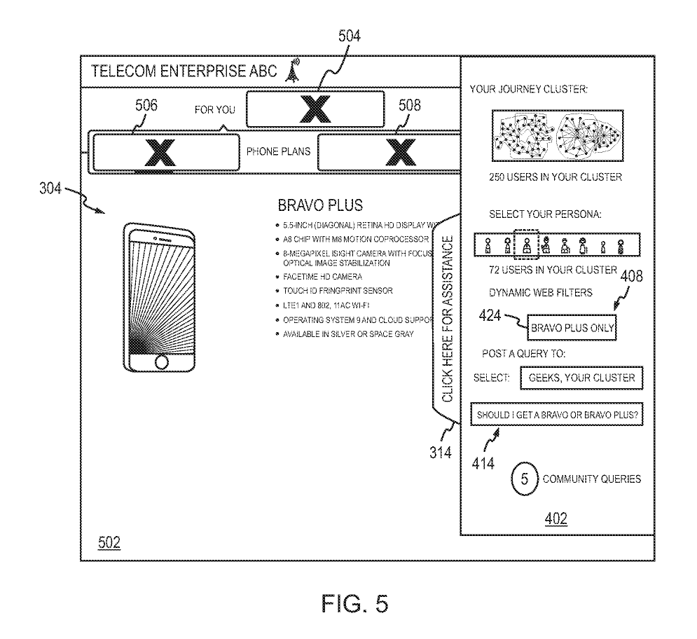

In at least one example embodiment, the system 200 may be caused to effect display of a first option and the second option on the interactive section. The first option may be configured to receive user input indicating user's intention for visiting the website. For example, the first option may be embodied as a text box capable of receiving user input. In an example scenario, the user may input text ‘Best fitness wrist bands,’ or ‘how to configure a virtual reality headset.’ Such user specified intention may be received by the system 200 and the system 200 may be caused to identify one or more relevant communities from among the plurality of communities based on the user specified intention. In an illustrative example, for the user specified intention ‘Best fitness wrist bands,’ the system 200 may be caused to identify communities related to two most widely used fitness tracking wristbands and/or a community dedicated to users comparing various fitness tracking products in the market. In at least some embodiments, the system 200 may be caused to customize content displayed on one or more UIs of the website based on user-specified or predicted user's intention, as will be explained later with reference to FIG. 5.

The second option displayed on the interactive section may be configured to receive user selection of a persona type from among a plurality of persona types. In an illustrative example, the second option may be configured to depict a series of thumbnails or miniaturized icons representative of various persona types and the user may select one or more persona types from among the depicted persona types. The term ‘persona type’ or ‘persona’ as used interchangeably hereinafter is representative of behavioral attributes associated with a group of users of the website. An example of a persona type may a ‘geek’ persona type that is representative of behavioral attributes associated with a group of users of the website who are more interested in specifications and technical details associated with products as compared to the aesthetic appeal or the price of the products. Another example of the persona type may be a ‘celebrity’ persona type that is representative of behavioral attributes associated with a group of users of the website who are more interested in aesthetic appeal of the product and are price insensitive. In an embodiment, the system 200 may be caused to identify one or more relevant communities from among the plurality of communities based on the user selected persona type. In some embodiments, the system 200 may be caused to assign weights to tracked user activity, selected persona type, and user specified intention to identify one or more relevant communities of users.

In some embodiments, in addition to displaying the first option and/or the second option on the interactive section, the system 200 may be caused to effect display of a representation illustrative of journeys of a plurality of users currently active on the website. For example, if one hundred other users are currently active on the website, then the interactive section may be configured to display a representation of their current journeys to the user on the interactive section. Further, the journeys of the plurality of users may be grouped into clusters based, at least in part, on a commonality in journey attributes. In an embodiment, the journey attributes relate to at least one of current Web page being viewed, user geography, browsing pattern, persona, and authentication status. The system 200 may be caused to classify active users into one or more clusters using clustering algorithms such as, for example, K-means algorithm, a self-organizing map (SOM) based algorithm, a self-organizing feature map (SOFM) based algorithm, a density-based spatial clustering algorithm, an optics clustering based algorithm, and the like. The cluster based representation of journeys of other users may enable the user to view browsing pattern and content viewed by other users associated with substantially similar journeys on the website.

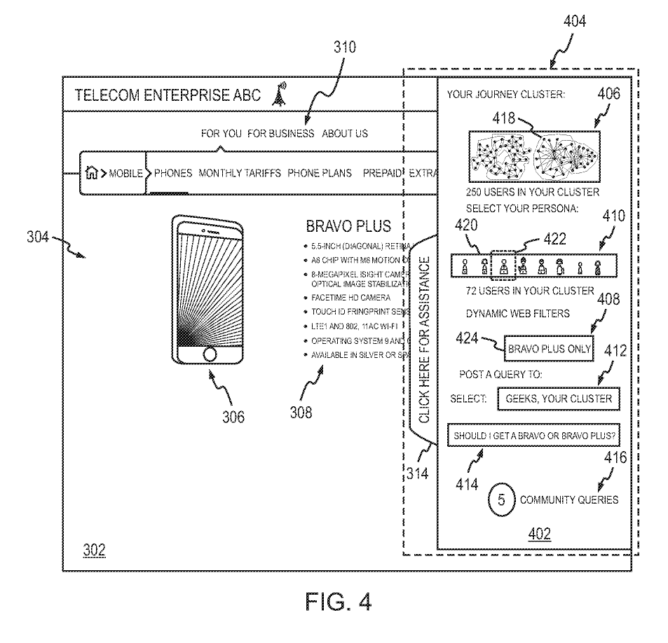

An interactive section configured to enable a user to post queries to one or more relevant communities of users and receive assistance is explained hereinafter with reference to FIGS. 4 to 7. The FIGS. 4 to 7 are explained as a continuation of the example explained with reference to FIG. 3 for illustration purposes.

Referring now to FIG. 4, an interactive section 402 displayed to a user on a portion 404 of the UI 302 of the website 304 during a current journey of the user on the website 304 is shown in accordance with an embodiment of the invention. As explained with reference to FIG. 3, a user selectable option 314 displaying text ‘CLICK HERE FOR ASSISTANCE’ is shown on the UI 302 and the user may provide a selection input on the user selectable option 314 to request assistance. Further, as explained with reference to FIG. 2, the system 200 may be caused to effect display of an interactive section upon receiving a user input indicative of a need for assistance. An example interactive section displayed to the user is shown in FIG. 4 as the interactive section 402. Although the interactive section 402 is depicted to be displayed on the portion 404 of the UI 302, in at least some embodiments the interactive section 402 may occupy substantial portion of UI 302. For example, the interactive section 402 may be superimposed on the entire area of the UI 302 if the user is viewing the website 304 on a relatively smaller screen associated with a device, such as a smartphone or a tablet device. Further, a placement of the interactive section 402 may not be limited to a column at the far right hand side of the UI 302. Indeed, the interactive section 402 may be displayed in any suitable location on the UI 302 so as to enhance ease of interaction for the user.

The interactive section 402 is depicted to display a representation 406 of journeys of active users on the website, a first option 408 for enabling the user to provide an input related to the user's intention, a second option 410 for enabling the user to select a persona type, a relevant community display 412, and a query input section 414. The interactive section 402 is also configured to display a number of queries 416 (exemplarily depicted to be five) associated with the relevant communities displayed in the relevant community display 412. The interactive section 402, including the representation 406, the first option 408, the second option 410, the relevant community display 412 and the query input section 414, are depicted herein for illustration purpose and that the interactive section 402 may include fewer or more elements displayed therein.

As explained with reference to FIG. 2, the active users may be grouped into clusters based on a commonality in journey attributes, such as a browsing pattern and the like. The term ‘cluster’ as used herein represents a group of users that have a common attribute, such as for example Web page sequence, current Web page being viewed, user geography, persona, user authentication status, and the like. Accordingly, the interactive section 402 displays the representation 406 showing journeys of active users on the website. The representation 406 depicts several clusters, such as cluster 418, with each cluster showing a specific sequence of Web page visited by a set of active users. Further, each cluster includes several interconnected nodes associated with numbers. The numbers depicted in the clusters represent Web pages or sequence steps in browsing. Based on the activity of the user on the website 304, the user may be associated with a cluster from among the clusters depicted in the representation 406. The cluster associated with a user may be highlighted by a distinct color to indicate to the user that the user belongs to that particular cluster. Further, a number of other users in the cluster associated with the user may also be mentioned, as exemplarily depicted by number ‘250’ in FIG. 4. It is noted that the representation of journeys of active users may not be limited to the graphical form of representation 406 as depicted in FIG. 4. For example, in some embodiments, the representation 406 may instead depict a number of users that are on the current page. The user may click on a cluster or on the number of users that are on the same current page to view what content other users with similar objectives have visited.

The second option 410 displayed on the interactive section 402 is depicted to be associated with text ‘Select your persona type’ and a gallery 420 showing miniaturized images representative of various persona types. Some non-limiting examples of persona types may include a ‘CEO’ persona type, ‘a homemaker (or a housewife)’ persona type, an ‘entrepreneur’ persona type, a ‘geek’ persona type, and the like. As explained with reference to FIG. 2, persona type refers to a representative behavior attributed to an entire group of users. For example, a ‘CEO’ persona type would typically be representative of a group of users who are driven by urgency in making a purchase or getting an issue resolved, and who may not be very price sensitive.

A user may select a persona type that is the closest representative of the user's persona. The selection can be provided by moving the slider 422 on the displayed miniaturized images and adjusting the slider 422 on top of the desired miniaturized image representative of the persona type to be selected. Upon selection of the persona type, a number of active users (exemplarily depicted to be 72), who share the same persona type is displayed to the user. In some embodiments, the system 200 may be caused to select a persona type for the user based on the tracked user activity. The user may further retain the selection or change the selection as per the user's preference. As explained with reference to FIG. 2, the user selection of the persona type may be used by the system 200 to identify one or more relevant communities of users to which the user may post queries.

The first option 408 is depicted to be associated with text ‘DYNAMIC WEB FILTERS’ and a text box 424, where the user may specify a nature of the user's requirement. The user is exemplarily depicted to have entered text ‘BRAVO PLUS ONLY.’ In some embodiments, the user specified intention (or in some cases, even predicted intention from user activity on the website 304) may be used as a dynamic content filter (or a dynamic web filter as suggested by the associated text portion) by the system 200 to customize content on the website. Such a scenario is depicted in FIG. 5.

Referring now to FIG. 5, a UI 502 with customized content displayed to the user is shown in accordance with an embodiment of the invention. The UI 502 corresponds to a customized version of the UI 302 of the website 304 explained with reference to FIGS. 3 and 4. More specifically, upon input of user specified intention in the text box 424 in the first option 408, one or more sections, such as section 504 corresponding to tabs ‘FOR BUSINESS’ and ‘ABOUT US,’ section 506 corresponding to sub tabs ‘PHONES’ and ‘MONTHLY TARIFFS’ and section 508 corresponding to tabs ‘PREPAID,’ ‘EXTRAS,’ ‘DEALS,’ and ‘NETWORK’ may be removed (exemplarily depicted by a cross or ‘X’ signs) and only content related to the Phone models (and especially content related to phone model ‘Bravo Plus’) may be retained. The customization of content may not be limited to the UI 502 (or more specifically the UI 302), and content on UIs related to other Web pages of the website 304 may also be customized to display content related to phone models only. Such a customization of content enables the user to view content that the user is interested in, while precluding the effort to sift through uninteresting content to identify content of importance.

Referring back to FIG. 4, the user specified intention in the first option 408, such as for example, ‘BRAVO PLUS ONLY,’ along with selected user persona may be used to identify one or more relevant communities to which the user may post queries. The relevant community display 412 is depicted to display identified relevant communities as ‘GEEKS’ and ‘YOUR CLUSTER’ for example purposes. The ‘GEEKS’ community may correspond to a group of users who are technically sound and have the capability to answer technical questions related to the phone model Bravo Plus. The other identified relevant community ‘YOUR CLUSTER’ may correspond to a group of users who have exhibited similar browsing journey as that of the user, and who may also be able to respond to the queries of the user because they share common interests.

In at least one embodiment, the identification of the one or more relevant communities may be performed in real-time upon user inputs related to the first option 408 and the second option 410. However, in some embodiments the user intention may be predicted from tracking user activity on the website, and the relevant communities may be identified based on the tracked user activity alone. In such a scenario, the relevant community display 412 may display the identified relevant communities upon display of the interactive section 402 prior to the user input related to the first option 408 and the second option 410. As explained above, the relevant communities are selected based on tracked user activity, selected persona type, user specified or prediction intention, and the like. In some embodiments, the relevant community display 412 may be configured to enable the user to change the chosen communities and add/delete a community. For example, the user may wish to post queries to only the ‘YOUR CLUSTER’ community. Accordingly, the user may delete the ‘GEEKS’ community from the relevant community display 412. In some embodiments, the relevant community display 412 may display a drop-down list showing other communities to the user. Further, a mouse-over or a click input on those communities may enable the user to view attributes (or definitions) associated with those respective communities, and choose a community that the user identifies as suitable for posting a query.

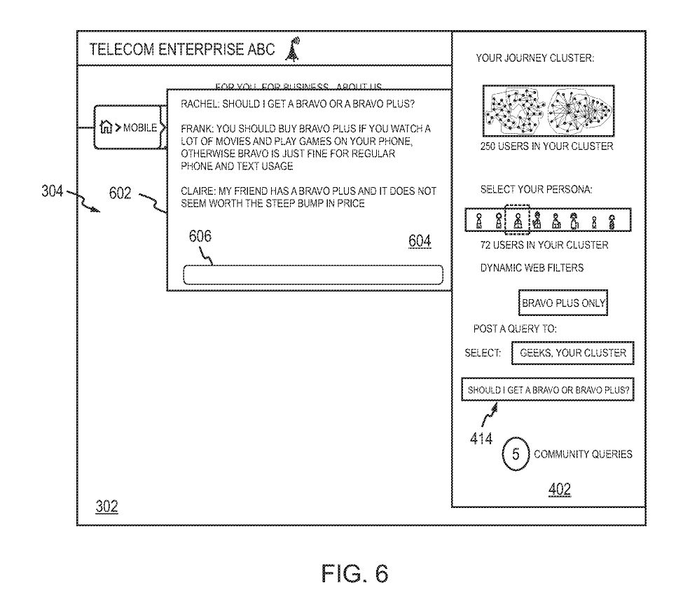

In FIG. 4, the user is depicted to have posted a query ‘SHOULD I GET A BRAVO OR A BRAVO PLUS?’ in the query input section 414. The query may be received by users associated with the ‘GEEKS’ and/or the ‘YOUR CLUSTER’ community. In at least one embodiment, one or more users from other any one or both communities may respond to the user query. As explained with reference to FIG. 2, the system 200 may be caused to facilitate an interaction between the user and the other users in the identified relevant communities and/or the agent using the interactive section 402. Such a scenario is depicted in FIG. 6.

FIG. 6 shows an example ongoing chat interaction 602 between the user and users of the identified relevant communities on the interactive section 302, in accordance with an embodiment of the invention. As explained with reference to FIG. 5, the user may post a query ‘SHOULD I GET A BRAVO OR A BRAVO PLUS?’ in the query input section 414. The query may be received by user communities associated with the ‘GEEKS’ community and the ‘YOUR CLUSTER’ community. The system 200 may be caused to effect display of a chat interface 604 upon receiving a response from at least one user or the agent associated with the identified relevant communities. The chat interface 604 depicts the ongoing chat interaction 602 between the user (exemplarily depicted to be ‘Rachel’) and other users ‘Frank’ and ‘Claire’. More specifically, in response to Rachel's query ‘SHOULD I GET A BRAVO ORA BRAVO PLUS?’ the user Frank is depicted to have responded with ‘YOU SHOULD BUY BRAVO PLUS IF YOU WATCH A LOT OF MOVIES AND PLAY GAMES ON YOUR PHONE, OTHERWISE BRAVO IS JUST FINE FOR REGULAR PHONE AND TEXT USAGE,’ whereas the user Claire is depicted to have responded with ‘MY FRIEND HAS A BRAVO PLUS AND IT DOES NOT SEEM WORTH THE STEEP BUMP IN PRICE.’ The user may interact with Frank, Claire, or other users by providing further text input in a chat entry box 606 associated with the chat interface 604, and Frank, Claire, or other users from the identified relevant communities, or even the agent, may respond to the subsequent text inputs from the user.

As can be seen from the chat interaction 602, the system 200 enables online users to identify themselves in communities and post queries to their own community or other communities. Such an approach is likely to lower the service cost of customers by enabling self-serve options for customers when they need help. This also helps the questions to be posted to the right forums.

Further, as explained with reference to FIG. 2, in at least some embodiments, other users or agents may rate answers to queries posted in their respective community forums. The system 200 may further be caused to determine the best rated answer for a query and store the best rated answer, as well as other answers in an archive. In some embodiments, the agent may be caused to display the best rated answer to a user query if the query has already been addressed adequately before. Such a scenario is depicted in FIG. 7.

FIG. 7 depicts a best rated answer 700 to a user in response to a user query in accordance with an embodiment of the invention. As explained with reference to FIG. 5, the user may post a query ‘SHOULD I GET A BRAVO ORA BRAVO PLUS’ in the query input section 414. The query may be received by user communities associated with the ‘GEEKS’ community and the ‘YOUR CLUSTER’ community. If the query had been received in either of communities and adequately addressed, then the agent associated with the respective community can respond with best rated answer to the query as depicted by display of the best rated answer 700 in the chat interface 604. If the user requires further clarification and has subsequent queries, then the user may input the query in the chat entry box 606 and the users from the identified relevant communities or the agent may respond to the queries and the chat interaction, such as the chat interaction 602 depicted in FIG. 6, may be facilitated on the chat interface 604. Accordingly, the user may receive answers to queries without having to wait for a prolonged duration of time to interact with a customer support representative and, further, the assistance may be provided to the user at the time of need for assistance.

Further, the interactive section 402 is depicted to display an archive section 702 showing a number of previous queries and responses (depicted to be ‘five’ each) which are related to the user query, and the user may click on responses or on the queries to view the past interaction history.

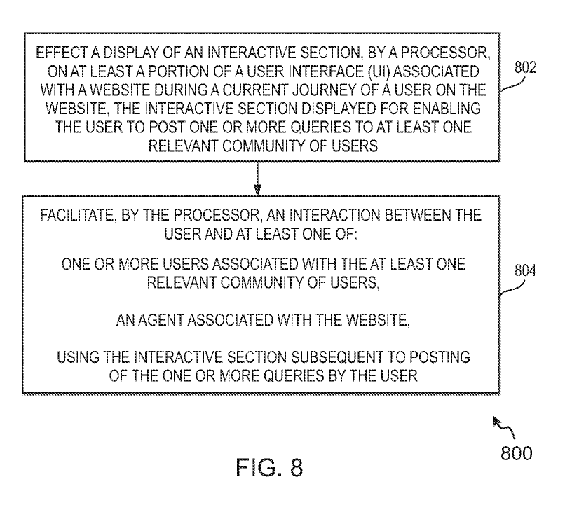

A method for serving an online user is explained with reference to FIG. 8.

FIG. 8 is a flow diagram of an example method 800 for serving an online user in accordance with an embodiment of the invention. The method 800 depicted in the flow diagram may be executed by, for example, the system 200 explained with reference to FIGS. 2 to 7. Operations of the flowchart, and combinations of operation in the flowchart, may be implemented by, for example, hardware, firmware, a processor, circuitry, and/or a different device associated with the execution of software that includes one or more computer program instructions. The operations of the method 800 are described herein with help of the system 200. The operations of the method 800 can be described and/or practiced by using a system other than the system 200. The method 800 starts at operation 802.

At operation 802 of the method 800, a display of an interactive section is effected by a processor on at least a portion of a user interface (UI) associated with a website during a current journey of a user on the website. As explained with reference to FIG. 2, an online user may visit a website of an enterprise for several reasons such as, for example, to view enterprise product/service offerings, to pay bills, to provide feedback, to register a complaint, and the like. In many scenarios, the users may have questions and may access the website to receive answers to their questions. For example, the users may wish to know more about product specifications, to enquire about billing or payment, to configure a product or troubleshoot an issue related to a product, to enquire about upgrades, to enquire about shipping of a product, to follow up about a previous query, and the like.

In at least one embodiment, a user selectable option, such as the user selectable option 314 explained with reference to FIG. 3, may be displayed on a user interface of each Web page associated with the website. The user selectable option may display a message such as for example ‘Need Help’ or ‘Speak with our agent.’ In case the user requires assistance at any stage during the current journey, the user may provide a click (or a touch) input to select the user selectable option to request desired assistance. In at least one embodiment, the user selectable option may be embodied as a tab, an icon, a floating widget, a fixed widget, an infographic, and the like. The interactive section, such as the interactive section 402 explained with reference to FIGS. 4 to 7, may be displayed on the UI of the website upon receiving user input corresponding to the user selectable option indicative of a need for assistance.

In at least one embodiment, the interactive section is displayed to enable the user to post one or more queries to at least one relevant community of users associated with the website. As explained with reference to FIG. 2, a plurality of community of users may be configured based on the users' attributes related to at least one of: purchase propensity, uniform resource locator (URL) categorization, sales or service categorization, current journey, online behavior, and omnichannel interaction data. Further, active users on the website may be classified into the plurality of communities. For an active user on a website seeking assistance, in at least one example embodiment, one or more community of users may be identified from among the plurality of community of users based on a commonality in activity on the website associated with the user and the identified community of users. The classification of active users based on their respective attributes into one or more communities may be performed as explained with reference to FIG. 2 and is not explained again herein.

In some embodiments, the at least one relevant community of users is identified based on user selection of persona or a user specified intention or predicted user intention, as explained with reference to FIG. 4. Further, in some embodiments, the content of one or more UIs may be customized based on the user specified intention on the interactive section. Such customization may be performed as explained with reference to FIG. 5 and is not explained herein.

At operation 804, the interaction between the user and at least one of (1) one or more users associated with the at least one relevant community of users, and (2) an agent associated with the website, is facilitated using the interactive section subsequent to posting of the one or more queries by the user. One or more agents may be dedicated to serve online users visiting the website. In an embodiment, each community of users may be assigned an agent who may supervise the interaction between the user and other users in the community, provide answers to queries if required, rate answers and, in general, provide assistance to the users associated with community. In at least one example embodiment, interaction, such as for example chat interaction, may be facilitated between the user posting the query and other users in the identified community and/or between the user and the agent associated with the community using the interactive section. In an embodiment, the interaction may be facilitated by effecting display of answers provided by the other users or the agent in response to the query posted by the user.

In some embodiments, a user query may have been previously asked and also answered by other users in the community of users. Accordingly, if a query posted by the user corresponds to a previously asked query, then previously provided answers provided to that query may be displayed to the user. In some embodiments, past interaction history associated with each of the one or more relevant communities of users may also be displayed on the interactive section upon receiving user request. The user may view past interaction history and receive answers/clarifications to the user's own query based on the prior question-answer related interactions associated with the community.

In some embodiments, answers to queries may be rated such that each answer is associated with rating. For example, answers to queries may be rated by users posting the queries or by other users or even agents monitoring the community interaction. In an illustrative example, an answer can be up-voted to indicate a positive rating or down-voted to indicate a negative rating. In another illustrative example, each answer may be associated with a five-star rating scale, and a user can click on stars to provide an indication of how useful the answer was, or whether the answer satisfactorily addressed the query or not. The individual ratings provided to an answer by several users and/or the agent may be used to compute an overall rating for the answer. For example, all ratings may be averaged to determine the overall rating for the answer. In at least one example embodiment, a best rated answer may be displayed to a user query using the interactive section. The interaction facilitated between the user and other users from the relevant community or between the user and the agent may be performed as explained with reference to FIGS. 6 and 7.

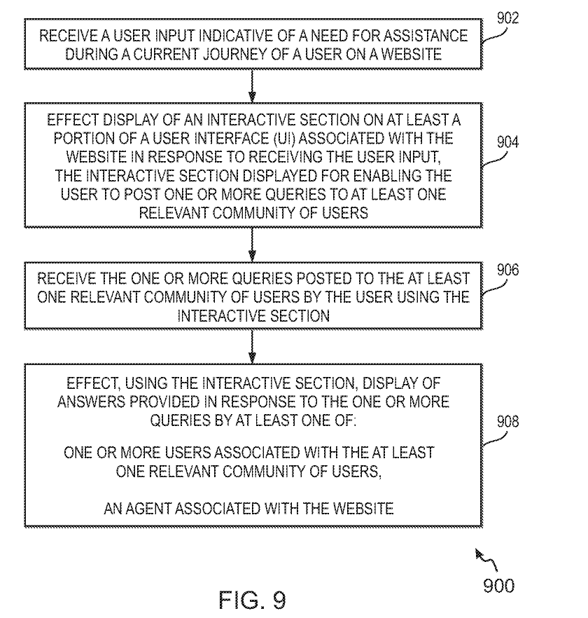

Although the method 800 relates to serving one online user, it is understood that other online users may be served in a similar manner. The method 800 stops at operation 804. Another method for serving an online user is explained with reference to FIG. 9.

FIG. 9 is a flow diagram of an example method 900 for serving an online user in accordance with another embodiment of the invention. The method 900 depicted in the flow diagram may be executed by, for example, the system 200 explained with reference to FIGS. 2 to 7. Operations of the flowchart, and combinations of operation in the flowchart, may be implemented by, for example, hardware, firmware, a processor, circuitry, and/or a different device associated with the execution of software that includes one or more computer program instructions. The method 900 starts at operation 902.

At operation 902 of the method 900, a user input indicative of a need for assistance during a current journey of a user on a website is received. The user input indicative of the need for assistance may be provided by provisioning a touch or a click input on a user selectable option, such as the user selectable option explained with reference to FIG. 3.

At operation 904 of the method 900, display of an interactive section is effected on at least a portion of a user interface (UI) associated with the website during the current journey of the user on the website in response to receiving the user input. The interactive section is displayed to enable the user to post one or more queries to at least one relevant community of users from among a plurality of community of users associated with the website. The effected of display of the interactive section may be performed as explained with reference to operation 802 of the method 800 in FIG. 8.

At operation 906 of the method 900, the one or more queries posted to the at least one relevant community of users by the user are received using the interactive section.

At operation 908 of the method 900, display of answers provided in response to the one or more queries by at least one of (1) one or more users associated with the at least one relevant community of users, and (2) an agent associated with the website, is effected using the interactive section. The method 900 stops at operation 908.

Without in any way limiting the scope, interpretation, or application of the claims appearing below, advantages of one or more of the exemplary embodiments disclosed herein provide numerous advantages. The techniques disclosed herein enable online users to identify themselves in communities and post queries to their own community or other communities. Such an approach is likely to lower the service cost of customers by enabling self-serve options for customers when they need help. This also helps the questions to be posted to the right forums. Further, techniques disclosed herein enable increased engagement of users on the website and, hence, potentially increase the revenues for the enterprises associated with the websites. It would also significantly reduce the cost of servicing the users by efficiently serving the users through self-service or by addressing queries in a community rather than one-on-one interactions.

The various embodiments disclosed herein enable users to provide information on their persona and behavioral traits so that they can find the right community to which they belong and post queries to the right community. The users can select their persona types, their intent, etc. to identify themselves with a community of users which similar profile. They can browse the activity pattern and interest graphs of other similar users or communities. The users can also post queries to their own or other communities. These questions may be answered by communities that can view the questions, and the responses may be viewed by all. The agents may post responses to question posted by customers, and the related communities can view and rate these responses. The agent may also address or refine the communities by collecting more data through dynamic forms.

The embodiments disclosed herein also suggest summarization of the responses, search of older archives, and/or automatic suggestion of the best responses to community questions based on historic data. The approach would also enable collection of user behavior data, and also help the user to drill-down to specific communities and reach out for help in real-time. In some embodiments, behavioral data collected, such as sections of website that are of interest or of no interest, enables reconfiguration of the Web design and content in real-time. For example, users completely focused on a particular brand of phone, may not be interested in viewing any other cell phone, the webpage content and design can be greatly simplified for them.

Various embodiments described above may be implemented in software, hardware, application logic, or a combination of software, hardware, and application logic. The software, application logic, and/or hardware may reside on one or more memory locations, one or more processors, an electronic device, or a computer program product. In an embodiment, the application logic, software, or an instruction set is maintained on any one of various conventional computer-readable media. In the context of this document, a “computer-readable medium” may be any media or means that can contain, store, communicate, propagate, or transport the instructions for use by or in connection with an instruction execution system, system, or device, as described and depicted in FIG. 2. A computer-readable medium may comprise a computer-readable storage medium that may be any media or means that can contain or store the instructions for use by or in connection with an instruction execution system, system, or device, such as a computer.

Although the present invention has been described with reference to specific exemplary embodiments, various modifications and changes may be made to these embodiments without departing from the broad spirit and scope of the invention. For example, the various operations, blocks, etc., described herein may be enabled and operated using hardware circuitry, for example, complementary metal oxide semiconductor (CMOS) based logic circuitry; firmware; software and/or any combination of hardware, firmware, and/or software, for example embodied in a machine-readable medium. For example, the systems and methods may be embodied using transistors, logic gates, and electrical circuits, for example, application specific integrated circuit (ASIC) circuitry and/or in Digital Signal Processor (DSP) circuitry.

Particularly, the system 200, the processor 202, the memory 204, the I/O module 206, and the communication interface 208 may be enabled using software and/or using transistors, logic gates, and electrical circuits, for example integrated circuit circuitry such as ASIC circuitry. Various embodiments of the invention may include one or more computer programs stored or otherwise embodied on a computer-readable medium, wherein the computer programs are configured to cause a processor or computer to perform one or more operations, for example operations explained herein with reference to FIGS. 8 and 9. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media, such as floppy disks, magnetic tapes, hard disk drives, etc.; optical magnetic storage media, e.g. magneto-optical disks, CD-ROM (compact disc read only memory), CD-R (compact disc recordable), CD-R/W (compact disc rewritable), DVD (Digital Versatile Disc), BD (Blu-ray (registered trademark) Disc); and semiconductor memories, such as mask ROM, PROM (programmable ROM), EPROM (erasable PROM), flash ROM, RAM (random access memory), etc. Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line, e.g. electric wires, and optical fibers, or a wireless communication line.

Various embodiments of the invention, as discussed above, may be practiced with steps and/or operations in a different order, and/or with hardware elements in configurations, which are different than those which are disclosed. Therefore, although the technology has been described based upon these exemplary embodiments, certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the invention set forth in the claims.

1. A computer-implemented method, comprising:
effecting, by a processor, display of an interactive section on at least a portion of a user interface (UI) associated with a website during a current journey of a user on the website;
identifying, by the processor, at least one relevant community of users, at least in part, based on the current journey of the user on the website;
the interactive section receiving one or more queries posted by the user to at least one relevant community of users from among a plurality of community of users associated with the website; and
subsequent to said posting of the one or more queries by the user to the interactive section effecting, by the processor, interaction between the user and at least one of:
one or more users associated with the at least one relevant community of users; and
an agent associated with the website.

2. The method of claim 1, further comprising:
receiving, by the processor, a user input during the current journey on the website, the user input indicative of a need for assistance, wherein the display of the interactive section is effected in response to receiving the user input.

3. The method of claim 1, further comprising:
tracking, by the processor, user activity on the website during the current journey of the user on the website.

4. The method of claim 3, further comprising:
performing at least one of prediction of user's intention and identification of the at least one relevant community of users based on the tracked user activity during the current journey of the user on the website.

5. The method of claim 1, further comprising:
customizing, by the processor, content displayed on one or more UIs of the website based on user-specified or predicted user's intention.

6. The method of claim 1, further comprising:
effecting, by the processor, display of a first option on the interactive section to receive user input indicating user's intention for visiting the website; and
using, by the processor, the indicated user's intention to identify the at least one relevant community of users.

7. The method of claim 6, further comprising:
effecting, by the processor, display of a second option on the interactive section to receive user selection of a persona type from among a plurality of persona types, wherein each persona type from among the plurality of persona types is representative of a set of behavioural attributes associated with a group of users of the website; and
using, by the processor, the selected persona type to identify the at least one relevant community of users.

8. The method of claim 1, further comprising:
effecting, by the processor, display of a representation illustrative of journeys of a plurality of users currently active on the website; and
grouping, by the processor, the journeys of the plurality of users into clusters based, at least in part, on a commonality in journey attributes.

9. The method of claim 8, wherein the journey attributes relate to any of current Web page being viewed, user geography, browsing pattern, user persona type, and user authentication status.

10. The method of claim 1, further comprising:
enabling, by the processor, the user to view content viewed by other users associated with substantially similar journeys on the website.

11. The method of claim 1, further comprising:
configuring, by the processor, the plurality of community of users based on user attributes related to related to any of purchase propensity, uniform resource locator (URL) categorization, sales or service categorization, current journey, online behaviour, and omnichannel interaction data; and
classifying, by the processor, a plurality of users currently active on the website into one or more communities from among the plurality of communities of users.

12. The method of claim 11, further comprising:
identifying, by the processor, a community of users from among the plurality of community of users based on a commonality in activity on the website associated with the user and the identified community of users; and
using, by the processor, the identified community of users to configure one of the at least one relevant community of users.

13. The method of claim 1, further comprising:
effecting, by the processor, display of a past interaction history associated with the at least one relevant community of users on the interactive section upon receiving a user request.

14. The method of claim 1, wherein facilitating the interaction comprises:
receiving, by the processor, answers provided by the one or more users or the agent to the user in response to the one or more queries posted by the user; and
effecting, by the processor, display of said answers provided by the one or more users or the agent to the user.

15. The method of claim 14, further comprising:
associating, by the processor, a rating with each answer from among the answers; and
determining, by the processor, the rating associated with the each answer based on individual ratings provided by users or agent associated with respective community of users from among the at least one relevant community of users.

16. The method of claim 15, further comprising:
effecting, by the processor, display of a best rated answer to at least one query from among the one or more queries posted by the user using the interactive section.

17. A system, comprising:
at least one processor; and
a memory having stored therein machine executable instructions, that when executed by the at least one processor, cause the system to:
effect display of an interactive section on at least a portion of a user interface (UI) associated with a website during a current journey of a user on the website;
identify at least one relevant community of users, at least in part, based on the current journey of the user on the website;
receive, via the interactive section, one or more queries posted by the user to at least one relevant community of users from among a plurality of community of users associated with the website; and
subsequent to said posting of the one or more queries by the user to the interactive section effect interaction between the user and at least one of:
one or more users associated with the at least one relevant community of users; and
an agent associated with the website.

18. The system of claim 17, the system is further caused to:
receive a user input during the current journey on the website, the user input indicative of a need for assistance, wherein the display of the interactive section is effected in response to receiving the user input.

19. The system of claim 17, wherein the system is further caused to:
track user activity on the website during the current journey of the user on the website.

20. The system of claim 19, wherein the system is further caused to:
perform at least one of prediction of user's intention and identification of the at least one relevant community of users based on the tracked user activity during the current journey of the user on the website.

21. The system of claim 17, wherein the system is further caused to:
customize content displayed on one or more UIs of the website based on user-specified or predicted user's intention.

22. The system of claim 17, wherein the system is further caused to:
effect display of a first option on the interactive section to receive user input indicating user's intention for visiting the website; and
use the indicated user's intention to identify the at least one relevant community of users.

23. The system of claim 22, wherein the system is further caused to:
effect display of a second option on the interactive section to receive user selection of a persona type from among a plurality of persona types, wherein each persona type from among the plurality of persona types is representative of a set of behavioural attributes associated with a group of users of the website; and
use the selected persona type to identify the at least one relevant community of users.

24. The system of claim 17, wherein the system is further caused to:
effect display of a representation illustrative of journeys of a plurality of users currently active on the website; and
group the journeys of the plurality of users into clusters based, at least in part, on a commonality in journey attributes.

25. The system of claim 24, wherein the journey attributes relate to any of current web page being viewed, user geography, browsing pattern, user persona type, and user authentication status.

26. The system of claim 17, wherein the system is further caused to:
enable the user to view content viewed by other users associated with substantially similar journeys on the website.

27. The system of claim 17, wherein the system is further caused to:
configure the plurality of community of users based on user attributes related to related to any of purchase propensity, uniform resource locator (URL) categorization, sales or service categorization, current journey, online behaviour, and omnichannel interaction data; and
classify a plurality of users currently active on the website into one or more communities from among the plurality of communities of users.

28. The system of claim 27, wherein the system is further caused to:
identify a community of users from among the plurality of community of users based on a commonality in activity on the website associated with the user and the identified community of users; and
using the identified community of users to configure one of the at least one relevant community of users.

29. The system of claim 17, wherein the system is further caused to:
effect display of a past interaction history associated with the at least one relevant community of users to the user on the interactive section upon receiving a user request.

30. The system of claim 17, wherein for facilitating the interaction, the system is further caused to:
receive answers provided by the one or more users or the agent to the user in response to the one or more queries posted by the user; and
effect display of said answers provided by the one or more users or the agent to the user.

31. The system of claim 30, wherein the system is further caused to:
associate each answer from among the answers with a rating; and
determine the rating associated with the each answer based on individual ratings provided by users or agent associated with respective community of users from among the at least one relevant community of users.

32. The system of claim 31, wherein the system is further caused to:
effect display of a best rated answer to at least one query from among the one or more queries posted by the user using the interactive section.

33. A computer-implemented method, comprising:
receiving, by a processor, a user input during a current journey of a user on a website, the user input indicative of a need for assistance;
effecting, by the processor, display of an interactive section on at least a portion of a user interface (UI) associated with a website during the current journey of the user on the website in response to receiving the user input;
identifying, by the processor, at least one relevant community of users, at least in part, based on the current journey of the user on the website;
the interactive section receiving one or more queries posted by the user to at least one relevant community of users from among a plurality of community of users associated with the website;
receiving using the interactive section, by the processor, the one or more queries posted to the at least one relevant community of users by the user; and
subsequent to said posting of the one or more queries by the user to the interactive section effecting, by the processor, display of answers provided in response to the one or more queries by at least one of:
one or more users associated with the at least one relevant community of users, and
an agent associated with the website.

34. The method of claim 33, further comprising:
customizing, by the processor, content displayed on one or more UIs of the website based on user-specified or predicted user's intention.

35. The method of claim 33, further comprising:
effecting, by the processor, display of a first option on the interactive section to receive user input indicating the user's intention to visit the website; and
using, by the processor, the indicated user's intention to identify the at least one relevant community of users.

36. The method of claim 35, further comprising:
effecting, by the processor, display of a second option on the interactive section to receive user selection of a persona type from among a plurality of persona types, wherein each persona type from among the plurality of persona types is representative of a set of behavioural attributes associated with a group of users of the website; and
using, by the processor, the selected persona type to identify the at least one relevant community of users.

37. The method of claim 33, further comprising:
effecting, by the processor, display of a past interaction history associated with the at least one relevant community of users to the user on the interactive section upon receiving a user request.

38. The method of claim 33, wherein facilitating the interaction comprises:
in response to the one or more queries posted by the user, effecting display of answers provided by the one or more users or the agent to the user.

39. The method of claim 38, further comprising:
associating, by the processor, a rating for each answer from among the answers; and
determining, by the processor, the rating associated with the each answer based on individual ratings provided by users or agent associated with respective community of users from among the at least one relevant community of users.

40. The method of claim 39, further comprising:
effecting, by the processor, display of a best rated answer to at least one query from among the one or more queries posted by the user using the interactive section.
